(19) United States
(12) Patent Application Publication
(10) Pub. No.: US 2020/0225727 A1
(43) Pub. Date: Jul. 16, 2020

(54) POWER DIVERTER FOR DONGLES USING TELEVISION POWERSOURCE

(71) Applicant: Douglas Hutchinson, Pittsburgh, PA (US)

(72) Inventor: Douglas Hutchinson, Pittsburgh, PA (US)

(21) Appl. No.: 16/744,439

(22) Filed: Jan. 16, 2020

Related U.S. Application Data
(60) Provisional application No. 62/792,946, filed on Jan. 16, 2019.

(51) Int. Cl. G06F 1/3215; G06F 1/3287; G06F 13/38

(52) U.S. Cl. CPC G06F 1/3215; G06F 2213/0042; G06F 13/382; G06F 1/3287

(57) ABSTRACT

Dongles are becoming increasingly popular for home entertainment, but as home entertainment includes more and more products wire clutter begins to occur. Dongles power cords add to this wire clutter. Some products use a television's USB-port for power, but then the dongle will not be able to stay on for ease of next use when the television is turned off. Wire clutter and the sleep mode problems can both be solved through the implementation of a power diverter between the television power cord and the television.

### CROSS-REFERENCE

This application claims the benefit of U.S. Provisional Application No. 62/792,946, filed Jan. 16, 2019, which application is incorporated herein by reference.

### BACKGROUND OF THE INVENTION

Dongles have become increasingly popular for adding viewing applications to a television. The dongles often plug into an HDMI-port or USB-port and additionally requires a plug into the wall for a power source. This configuration leads to more clutter of wires near the entertainment system.

Some after-market products set out to get rid of the clutter through the power source being the power source of the television using the television's USB port. A problem with using a television USB port for power is not all televisions have a USB port. Moreover, the dongle, when plugged into the USB-port, turns off when the television is turned off. The dongle being left on, has aspects.

The invention here is placed between the television power cord and the television allowing the wire clutter to be reduced, but also allows the dongle to stay on when the television is turned off.

### SUMMARY OF THE INVENTION

In some embodiments, a power diverter includes: a plug, configured to be plugged into a jack of a television power cord, a jack opposite to said plug to be plugged into a plug of a television, and a port for a dongle's power cord. In some embodiments, a power diverter further includes an adaptation to satisfy different types of televisions. In some embodiments, the power diverter redistributes five-volts for said dongle.

In some embodiments, a method of supplying power to a dongle includes: plugging a television power cord into a power diverter, plugging said power diverter into a television, and plugging a dongle into said power diverter, wherein said power diverter supplies power from the power cord to both the television and said dongle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of one embodiment of the power diverter.

FIG. 2 is an exemplary illustration of one embodiment of the power diverter.

FIG. 3 is an exemplary illustration of one embodiment of the system when the power diverter is utilized.

### DETAILED DESCRIPTION OF THE INVENTION

In some embodiments, the power diverter is placed between the television power cable and the television. In some embodiments, a cable goes from the power diverter to the dongle. In some embodiments, the power diverter is retrofitted for the designated television and power cord type needed. In some embodiments, the power diverter takes power from the television power cord and diverts the power to the dongle or another device.

In some embodiments, the diverter provides the user with an always-on 5-volt USB-port without running additional wires from the wall or requiring the television to be on. The diverter can be used with any device that uses a USB power source, some non-limiting examples include, Roku, Amazon Fire Stick, Chromecast. The device can be constructed for delivering 5 volts other volt amounts to products.

In some embodiments, the diverter is used by unplugging the existing power cord from the back of the television, plugging the power cord into the jack (or the female end receptacle, socket, or clot) of the adapter, plugging the plug (or the male end plug, pin, or prong) of the adapter into the television, and the USB-port on the adapter will always be on. In some embodiment, the television continues to function the same as before the adapter was installed.

A dongle can be any device that plugs into a television and requires external power. In some embodiments, dongles are powered by USB power sources, such as a 5-volt USB power source.

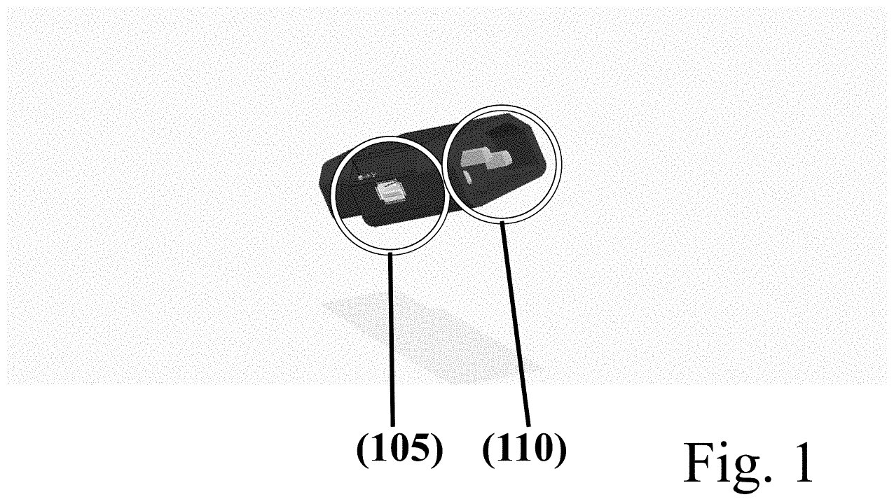

FIG. 1 depicts the plug of one embodiment of the power diverter. In this embodiment, the male prongs of the plug (110) plug into the jack of a television power cord. This embodiment has the port (105) for the dongle power supply on the side of the diverter. A power cord from the dongle can be plugged into this side port to supply power even when the television is turned off.

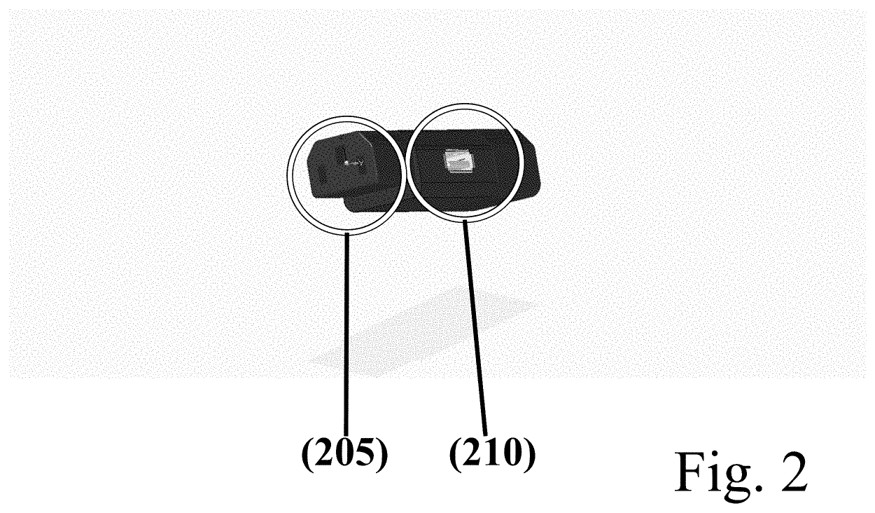

FIG. 2 depicts the jack of one embodiment of the power diverter. In this embodiment, the jack (205) is plugged into the male pins of the plug of the television. In this embodiment, the power diverter has the port (210) for the dongle to be plugged in on the side.

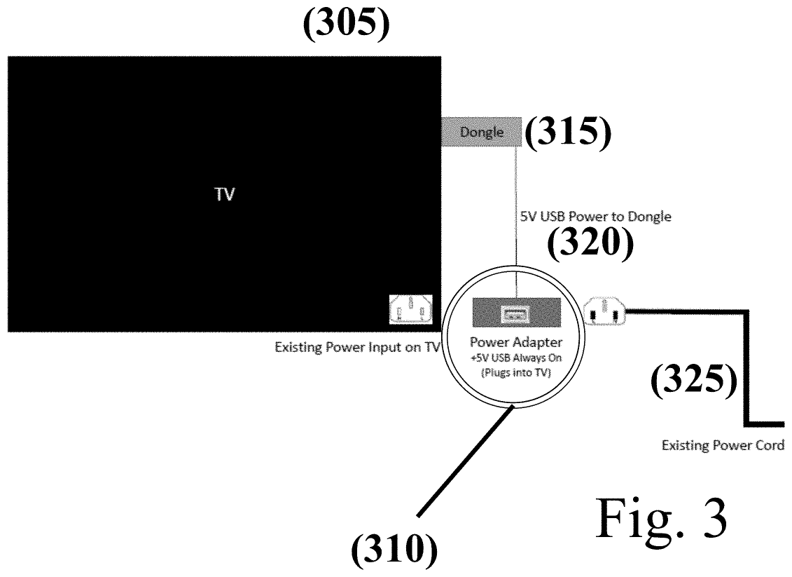

FIG. 3 depicts one embodiment of the system including a television, power diverter, dongle, and power cord. In this embodiment, an existing power cord (325) runs from an outlet to the power diverter (310), which is further plugged into the television (305) power input. The dongle (315) can be plugged into the power diverter (310) for a five-volt USB power source that is always on.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A power diverter comprising:
a plug, configured to be plugged into a jack of a television power cord,
a jack opposite to said plug to be plugged into a plug of a television, and
a port for a dongle's power cord.

2. A power diverter as in claim 1, further comprising an adaptation to satisfy different types of televisions.

3. A power diverter as in claim 1, wherein said power diverter redistributes five-volts for said dongle.

4. A method of supplying power to a dongle comprising:
plugging a television power cord into a power diverter,
plugging said power diverter into a television, and
plugging a dongle into said power diverter, wherein said power diverter supplies power from the power cord to both the television and said dongle.
